(19) United States
(12) Patent Application Publication
(10) Pub. No.: US 2018/0345239 A1
(43) Pub. Date: Dec. 6, 2018

(54) FLUIDIZED BED REACTOR AND METHOD FOR PRODUCING POLYCRYSTALLINE SILICON GRANULES

(71) Applicant: Wacker Chemie AG, Munich (DE)

(72) Inventor: Simon PEDRON, Burghausen (DE)

(73) Assignee: Wacker Chemie AG, Munich (DE)

(21) Appl. No.: 15/777,851

(22) PCT Filed: Nov. 7, 2016
(86) PCT No.: PCT/EP2016/076776

§ 371 Date: May 21, 2018

(30) Foreign Application Priority Data
Dec. 2, 2015 (DE) 10 2015 224 099.1

(51) Int. Cl. B01J 8/18; C01B 33/029

(52) U.S. Cl. CPC B01J 8/1827; B01J 8/1836; B01J 8/1881; B01J 2208/00902; B01J 2208/00477; B01J 2208/00115; B01J 2208/00769; C01B 33/029

(57) ABSTRACT

By disposing a radiation shield between a heater insulator and the heater in a fluidized bed reactor for producing granular polysilicon, significant energy savings are obtained.

### CROSS REFERENCE TO RELATED APPLICATIONS

This application is the U.S. National Phase of PCT Appln. No. PCT/EP2016/076776 filed Nov. 7, 2016, which claims priority to German Application No. 10 2015 224 099.1 filed Dec. 2, 2015, the disclosures of which are incorporated in their entirety by reference herein.

### BACKGROUND OF THE INVENTION

### 1. Field of the Invention

The invention relates to a fluidized bed reactor and a method for producing polycrystalline silicon in granular form.

### 2. Description of the Related Art

Granular polycrystalline silicon is manufactured in a fluidized bed reactor. Silicon particles are fluidized by the gas flow in the fluidized bed, the latter being heated to high temperatures via a heating device. A silicon-containing reaction gas is admixed for a deposition reaction at the hot surface of the particles. Elemental silicon deposits on the silicon particles and the individual particles increase in diameter. By regularly withdrawing grown particles and admixing smaller seed silicon particles, the method can be operated in a continuous manner with all its attendant advantages. Silicon-containing reactant gases described include silicon-halogen compounds (e.g., chlorosilanes or bromosilanes), silane (SiH₄), and also mixtures of these gases with hydrogen. In this method, a significant proportion of the heating power used is lost via cooled reactor outside walls. To increase the energy efficiency of the reactor and hence also of the method for producing polycrystalline silicon in granular form, it is known for reactor components that heat up to high temperatures in the process to be thermally insulated from the cooled shell of the reactor.

U.S. 2000/0677347 thus discloses a fluidized bed reactor having an insulant between the radiant heater and the outside wall of the reactor. The insulant preferably consists of quartz or metal silicates.

U.S. Pat. No. 5,798,137 A discloses an alumina-silica fiber insulant in the heating jacket of a fluidized bed reactor.

U.S. 2009/004090 A discloses putting an inorganic type of insulation material inbetween the heater and the outer shell of the reactor.

### SUMMARY OF THE INVENTION

The problem addressed by the invention is that of providing a fluidized bed reactor for production of polycrystalline silicon in granular form by deposition of polycrystalline silicon onto silicon seed particles which has a higher energy efficiency than any known fluidized bed reactor. The problem is solved by a fluidized bed reactor comprising a reactor container,

an inner reactor tube for a fluidized bed comprising granular polysilicon,
a reactor bottom within the reactor container,
at least one bottom gas nozzle for feeding fluidization gas, and also
at least one reaction gas nozzle for feeding a reaction gas mixture,
feed means for feeding silicon seed particles, and also a discharge line for granular polysilicon, and
means for leading reactor exit gas out of the reactor container,
an interspace situated between the reactor container and the inner reactor tube and containing
a heating device for heating the fluidized bed in the inner reactor tube, and also
an insulation material,
characterized in that radiation shields are present in the interspace between the heater and the insulation material and the interspace contains an inert gas.

### BRIEF DESCRIPTION OF THE DRAWINGS

FIG. 1 illustrates a side view of one embodiment of a reactor of the invention;

FIG. 2 illustrates one embodiment of a cylindrical radiation shield of the invention.

### BRIEF DESCRIPTION OF THE DRAWINGS

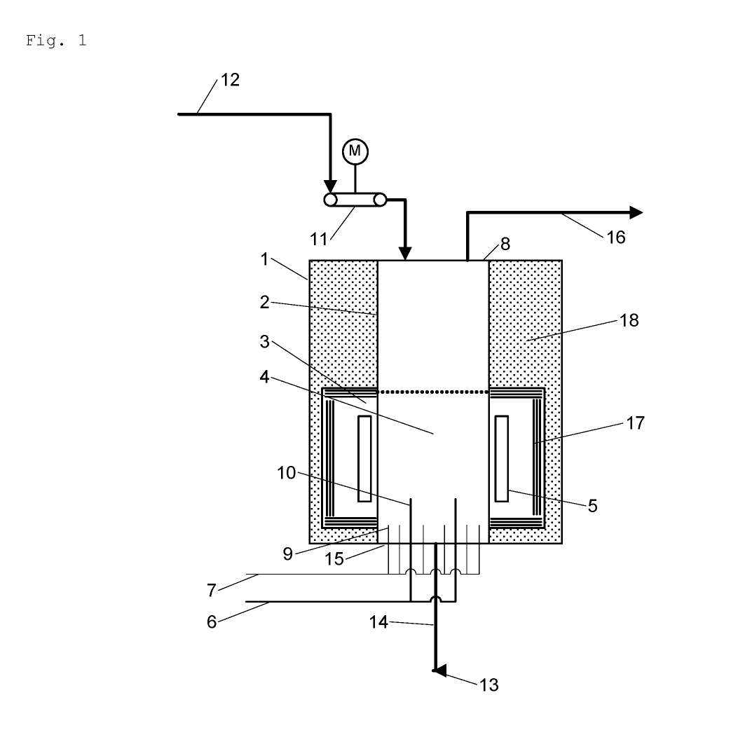

A preferred embodiment of the invention is depicted in FIG. 1. This fluidized bed reactor comprises

a reactor container (1),
an inner reactor tube (2) for a fluidized bed (4) comprising granular polysilicon,
a reactor bottom (15),
one or more bottom gas nozzles (9) for supplying the inner reactor tube (2) with a fluidization gas (7), and
one or more reaction gas nozzles (10) for supplying the inner reactor tube (2) with a reaction gas mixture (6),
a reactor head (8) via which a seed feed device (11) supplies the inner reactor tube (2) with seeds (12),
a discharge line (14) at the reactor bottom (15), via which the granular polysilicon product (13) is discharged,
a conduit or other device for leading reactor exit gas (16) out of the inner reactor tube (2),
a heating device (5) for heating the fluidized bed (4),
an insulation material (18) in the interspace between the inside wall of the container (1) and the outside wall of the inner reactor tube (2),
characterized in that radiation shields (17) are present in the interspace (3) between the heater (5) and the insulation material (18) and the interspace (3) contains an inert gas.

The height of the reaction gas nozzles (10) in the reactor may differ from the height of the bottom gas nozzles (9). The arrangement of the nozzles is responsible for the formation, inside the reactor, of a bubble-forming fluidized bed with additional vertical secondary gas injection.

The reactor head (8) may have a larger cross section than the fluidized bed.

The radiation shields (17) are situated on that side of heater (5) which is remote from the inner reactor tube. They are preferably arranged about the heater (5). More preferably, a circularly ring-shaped radiation shield is attached above the heater (5), a circularly ring-shaped radiation shield is attached below the heater (5), and a cylindrical radiation shield is attached behind the heater (5). It is also possible here for the upper radiation shield and the cylindrical radiation shield or the lower radiation shield and the cylindrical radiation shield to be combined with each other.

The radiation shields are effective in shielding off the container walls of the reactor, less energy passing into the cooled wall than with solely an insulant. The heat loss through radiation is thus significantly reduced by the radiation shields. The insulants are left to absorb but a fraction of the thermal radiation from the heater and hot internals.

It is advantageous for the purposes of the present invention when the radiation shield has a very low emissivity ε and/or a very high reflectivity. It is further advantageous when the radiation shield is constructed of a very large number of plies.

A radiation shield may consist of one or more plies. A radiation shield consists with preference of one to 20 plies, more preferably with one to 10 plies and most preferably with one to 7 plies.

A ply of a radiation shield may be a single piece or consist of two or more mutually riveted, welded, push fitted, bolted, monolithically bonded, sintered, reaction-sintered, soldered, adhered or side-by-side panels each from 0.05 to 30 mm, preferably from 0.05 to 10 mm and more preferably from 0.2 to 5 mm in thickness. The individual plies of a radiation shield need not be gastight.

The individual plies are spaced apart from each other by a gap of 1 to 150 mm, preferably 1 to 50 mm and more preferably 2 to 15 mm.

The gap between the individual plies is ensured by spacers and/or, in the event of a nonplanar configuration, by characteristic dimensions of the individual plies and spacers. In the case of a cylindrical heat shield for example, the diameter of the individual plies and the thickness of the spacers have to be aligned with each other. Suitable spacers are preferably struts, ribs, dimples, rings, profiled panels such as, for example, U-profiles or corrugated panels or structures consisting of solid material, examples being cuboids, pyramids, cylinders or other customary geometric shapes.

Where the radiation shield concludes vertically to the individual plies, devices for holding the individual plies may be present in the concluding surface.

The spacers and the individual plies of the radiation shield are preferably connected to each other by welding, soldering, sintering, reaction-sintering, monolithically, a bolted connection, a riveted connection, a push fit connection or an adhesive bond.

Where the heat loss through convection between the individual plies of the radiation shield is to be minimized, the radiation shield may be closed off at the outside surfaces and optionally, in the case of a gastight configuration, evacuated. Alternatively or additionally, obstacles for stopping thermally induced convection may be incorporated between the individual plies of the radiation shield. Obstacles of this type include, for example, structures of solid material which completely or partially close off the free cross section for flow in the case of natural or forced convection. In a cylindrical upright heat shield for instance, horizontally arranged annular panels may be incorporated between the individual plies.

Depending on what is required of the temperature profile in the reactor tube, the individual radiation shields may be configured such that the individual plies are planar or circumferential surfaces of a cylinder of round or oval base or of a body having a polygonal base.

Openings in the radiation shields have to be realized according to the installed position, for example for temperature measurements, heater ducts, for gas ducting or for the assembly device.

The individual ply of the radiation shield preferably contains one or more of the following materials: silicon dioxide, silicon carbide, silicon, carbon, aluminum oxide, molybdenum, tungsten, nickel or chromium.

It is particularly preferable for the radiation shield to contain quartzite, quartz ceramic, quartz glass, quartz glass with reflective SiO₂ coating, molybdenum or molybdenum alloys such as, for example, molybdenum/lanthanum oxide, tungsten or a tungsten alloy, steel alloys, for example 1.4828-X 15 CrNiSi 20 12 2; 1.4872-X 25 CrMnNi 25 9 7; 1.4876-X 10 NiCrAlTi 32 21; 1.4841-X 15 Cr Ni Si 25 21, nickel based alloys, for example 2.4663-NiCr₂₃Co₁₂Mo, graphite, carbon fiber reinforced carbon (CFC), graphite foil, recrystallized, nitride bonded, sintered or silicon infiltrated silicon carbide, and/or sintered silicon nitride.

It is most preferable for the radiation shield to contain molybdenum or a molybdenum alloy, for example Mo/La, tungsten or a tungsten alloy, CFC, graphite or steel alloys, for example 1.4828-X 15 CrNiSi 20 12 2; 1.4872-X 25 CrMnNi 25 9 7; 1.4876-X 10 NiCrAlTi 32 21; 1.4841-X 15 Cr Ni Si 25 21, nickel based alloys, for example 2.4663-NiCr₂₃Co₁₂Mo.

Preferably, the individual plies of a radiation shield consist of any one of the recited materials, while the materials of the individual plies may be different. In one particularly preferred embodiment, the radiation shield consists of one of the recited materials and is wrapped on the inside surface and/or the outside surface with a graphite foil from 5 μm to 5 mm in thickness.

In another particularly preferred embodiment, the radiation shield consists of any one of the recited materials and is coated on the inside surface and/or outside surface with a CVD layer of carbon (“pyrographite” or “pyrocarbon”) from 3 μm to 5 mm in thickness.

In a further preferred embodiment, the radiation shield consists of any one of the recited materials and is coated, wrapped or bonded on the inside surface and/or outside surface with/to a layer, a foil or a panel from 1 μm to 5 mm in thickness and consisting of the principal constituents molybdenum or tungsten.

In a further particularly preferred embodiment, the radiation shield consists of any one of the recited materials and is coated, wrapped or bonded on the inside surface and/or outside surface with/to a layer, a foil or a panel from 1 μm to 5 mm in thickness and consisting of silver or gold.

In a further particularly preferred embodiment, the radiation shield consists of any one of the recited materials and is coated, wrapped or bonded on the inside surface and/or outside surface with/to a layer, a foil or a panel from 1 μm to 5 mm in thickness and consisting of a material having a >40% reflectivity with regard to thermal radiation at the service temperature.

The fluidized bed reactor of the present invention reduces the cost of methods for producing granular polysilicon. The present invention accordingly also provides a method for producing granular polysilicon, which method comprises fluidizing silicon seed particles using a gas flow in a fluidized bed being heated by a heating device, wherein admixing a silicon-containing reaction gas under pyrolysis is used to deposit polycrystalline silicon on the hot seed particle surfaces to thereby form the granular polysilicon, characterized in that the reaction is carried out in a reactor of the present invention.

Such a method is carried out like prior art methods except that a significant energy saving is obtained versus customary methods.

Preferably, the pressure in the interspace between the inside wall of the reactor container and the outside wall of the inner reactor tube is higher than in the inner reactor tube in the practice of the method.

Preferably, the interspace between the inside wall of the reactor container and the outside wall of the inner reactor tube is flushed with inert gas.

The inert gas preferably comprises nitrogen, argon, helium or carbon dioxide.

FIG. 1 shows an above-described preferred embodiment of the fluidized bed reactor according to the present invention.

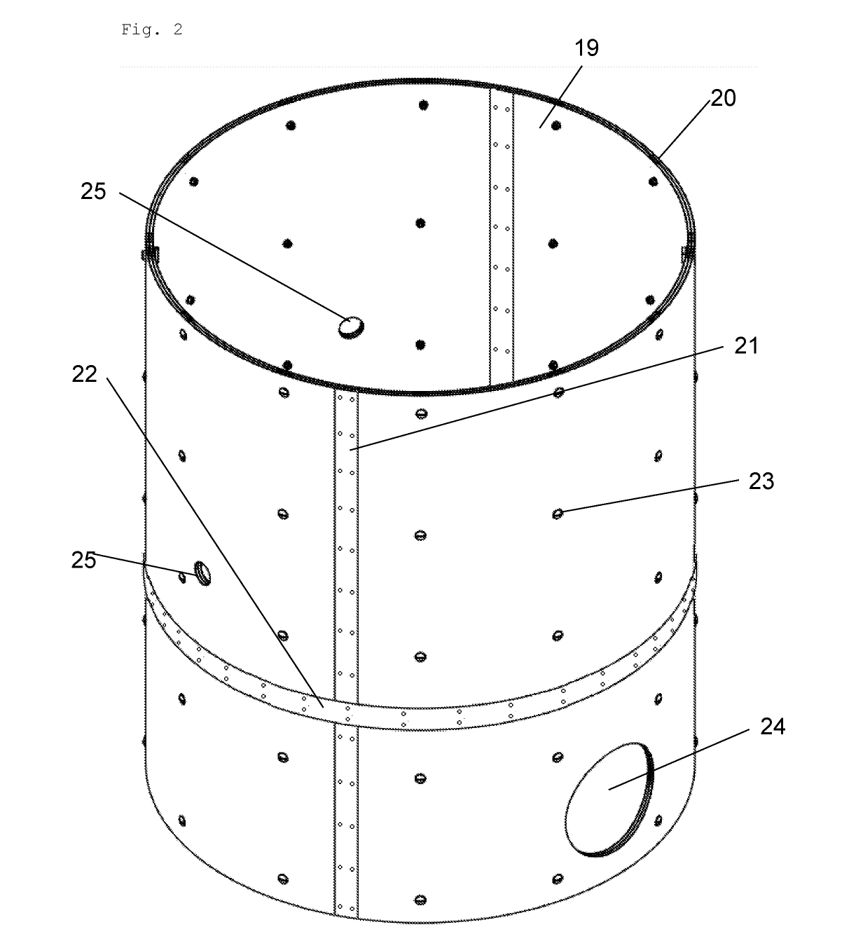

FIG. 2 shows a design example of a cylindrical radiation shield (19) having U-profiles (20) as spacers. The radiation shield consists of molybdenum. The three plies consist of mutually riveted panels (21, 22) and are mutually bolted together (23). The gap between the individual plies is 5 mm, the panel thickness is 0.5 mm. There are drilled holes for electrode ductings of the radiant heater (24) and for temperature measurement with pyrometers (25).

The example which follows serves to further elucidate the invention.

### Example 1

In a fluidized bed reactor according to FIG. 1, but without radiation shield, high-purity polysilicon in granular form was deposited from trichlorosilane. Hydrogen was used as a fluidization gas. Deposition took place at a pressure of 4.5 bar (abs) and a temperature of 1000° C. Product was withdrawn in a continuous manner and the seed feed was controlled such that the Sauter diameter of the product was 1000±50 μm. The intershell was flushed with nitrogen. Altogether 800 kg/h of gas were supplied. A deposition rate of 30.4 kg h⁻¹ was obtained.

The insulant about the radiant heater had a thickness of 150 mm and consisted of hard carbon fiber felt. No radiation shields were present. The heater required a heating power output of 402 kW for this process.

The same process was run under the same operating conditions in an identically constructed reactor but with radiation shield. The thickness of the insulant about the heater was 120 mm, and a five-ply radiation shield of tungsten was situated between the insulant and heater. As is apparent from FIG. 1, radiation shields were also situated above and below the heater, the insulants being reduced in each case by the thickness of the radiation shields (altogether 30 mm). The heater required a heating power output of 375 kW for this process. This corresponds to a saving of 6.7%.

1.-10. (canceled)

11. A fluidized bed reactor for production of polycrystalline silicon in granular form, said reactor comprising:
a reactor container,
an inner reactor tube for a fluidized bed comprising granular polysilicon,
a reactor bottom within the reactor container,
at least one bottom gas nozzle for feeding fluidization gas,
at least one reaction gas nozzle for feeding a reaction gas mixture,
a silicon seed particle feed,
a discharge line for withdrawing granular polysilicon, and
a reactor gas exit,
an interspace situated between the reactor container and the inner reactor tube, containing
a heater device for heating the fluidized bed in the inner reactor tube,
an insulation material, and
a radiation shield in the interspace between the heater and the insulation material, wherein the interspace contains an inert gas.

12. The fluidized bed reactor of claim 11, wherein at least one radiation shield is arranged about the heater.

13. The fluidized bed reactor of claim 11, wherein a circularly ring-shaped radiation shield is attached above the heater, a circularly ring-shaped radiation shield is attached below the heater, and a cylindrical radiation shield is attached outside the heater.

14. The fluidized bed reactor of claim 11, wherein the radiation shield consists of one to 20 plies.

15. The fluidized bed reactor of claim 13, wherein the radiation shield consists of one to 20 plies.

16. The fluidized bed reactor of claim 11, wherein the radiation shield comprises one or more of the following materials: silicon dioxide, silicon carbide, silicon, carbon, aluminum oxide, molybdenum, tungsten, nickel or chromium.

17. The fluidized bed reactor of claim 16, wherein the individual plies of the radiation shield consist of any one of the recited materials, while the materials of individual plies may be different.

18. A method for producing granular polysilicon, which method comprises fluidizing silicon seed particles using a gas flow in a fluidized bed being heated by a heating device so as to heat the silicon seed particles, producing hot silicon seed particles, and admixing a silicon-containing reaction gas under pyrolysis conditions to deposit polycrystalline silicon on surfaces of the hot seed particle to thereby form the granular polysilicon, wherein the method is carried out in a fluidized bed reactor of claim 11.

19. The method of claim 18, wherein the pressure in the interspace between the inside wall of the reactor container and the outside wall of the inner reactor tube is higher than in the inner reactor tube.

20. The method as claimed in claim 18, the interspace between the inside wall of the reactor container and the outside wall of the inner reactor tube is flushed with inert gas.
